(19) United States
(12) Patent Application Publication
(10) Pub. No.: US 2015/0134436 A1
(43) Pub. Date: May 14, 2015

(54) ELECTRONIC COMMERCE REDEEMABLE TICKET

(71) Applicant: Stephen Charles Basil LAMBERT, Kangaroo Point, Queensland (AU)

(72) Inventor: Stephen Charles Basil Lambert, Zillmere (QLD) (AU)

(21) Appl. No.: 14/398,355

(22) PCT Filed: May 2, 2013
(86) PCT No.: PCT/AU2013/000460

§ 371 Date: Oct. 31, 2014

(30) Foreign Application Priority Data
May 3, 2012 (AU) 2012901813
Jul. 13, 2012 (AU) 2012903008

(51) Int. Cl. G06Q 20/32; G06Q 20/38; G06Q 30/02

(52) U.S. Cl. CPC G06Q 20/3274; G06Q 30/0225; G06Q 30/0267; G06Q 20/387
USPC 705/14.26

(57) ABSTRACT

An electronic commerce ticket comprised in a redeemable ticket system including: a server side program operable on one or more servers and having: a server side communications module facilitating communication with customer devices and seller devices; a membership module for receiving and storing customer information; a seller module for receiving and storing seller information; a data module accessible by sellers for storing offers and generating verification codes associated with each offer for distribution sellers; and for distributing offers to one or more customers, and comparing verification codes associated each offer; and a client side program operable on each of the client devices and having: a client side communications module for uploading one or more offers to the servers for distribution with the verification codes to the customers by accessing their customer devices whereby one or more customers may take up any such offer by communicating the relevant verification codes to the relevant sellers.

This invention relates to an electronic commerce ticket comprised in a redeemable ticket system. The invention has particular application to a system for electronically generating and redeeming ticket in the form of a discount coupon via a smart mobile telephone accessing the cellular wireless telephone network. However, the invention has more general application to electronically redeemable tickets which may be obtained and/or redeemed online or through other forms of network.

Discount tickets may be referred to as vouchers, coupons or such like, and the term ticket used herein is to be taken to encompass vouchers, coupons and such like unless the context indicates otherwise. Discounts may be offered from time to time by traders by publishing or otherwise issuing tickets printed with the terms of the offer. The printing and distribution of printed tickets is costly and target markets cannot always be accurately or effectively supplied with such tickets. Additionally, the redemption of such tickets is often inefficient and time consuming, and sometimes prone to error. Some traders do not bother with the verification of tickets due to the additional work load on counter staff. Some traders merely sight the coupon, relying on the discount being recorded at the till and the gathering of information for marketing purposes from the till record.

New technology, particularly in the information and communications area, is changing and presents an increasingly important challenge to get marketing messages to the consumer, but it is recognised that such technology may provide for such messages to be delivered directly to the consumer in real time. Traditional marketing strategies involve high costs per consumer impression and are generally very broad in their targeting. The return rates on traditional marketing strategies vary quite widely as being very low from brochure drops to relatively high from television and radio advertising campaigns. These strategies remain very broad in their targeting.

Coupon booklets have been provided which involve the consumer buying a booklet of coupons to redeem at a later stage from the retailer for a discount. Such arrangements become cost effective for the consumer if they use more than a threshold number of coupons or discount tickets. Web-based marketing strategies exist that make a one off, time limited, offer that must have a minimum number of customers take up the offer before it becomes valid. Some web-based marketing sites issue printable vouchers which require the customer to be near a computer and a printer to be able to make use of the offer. Some vendors have created applications for smart phones that deliver an offer to members for in store discounts. Such systems have been haphazard in their application as they rely on existing customers to have the app loaded and may not be taking advantage of the full potential of electronic commerce as it develops.

The present invention aims to provide an electronic commerce ticket comprised in a redeemable ticket system which addresses the aforementioned problems. Other aims and advantages of the invention may become apparent from the following description.

With the foregoing in view, in one aspect the present invention resides broadly in an electronic commerce ticket comprised in a redeemable ticket system including:

a server side program operable on one or more servers and having:

a server side communications module operable for communication with a plurality of client devices comprising one or more customer devices and one or more seller devices;

a membership module associated with said server side communications module and operable to receive and store information relevant to one or more customers associated with said one or more customer devices;

a seller module associated with said server side communications module and operable to receive and store information relevant to one or more sellers associated with said one or more seller devices;

a data module operatively associated with said seller module and accessible by said one or more sellers for storing information relevant to one or more offers and generating one or more verification codes associated with the or each offer for distribution to said one or more sellers; and

a control module associated with said server side communications module and said data module for distributing said one or more offers to said one or more customers, and comparing said one or more verification codes associated with the or each offer;

a client side program operable on each one of said plurality of client devices and having:

a client side communications module operable for communication with said one or more servers, whereby said one or more sellers may upload one or more offers to said one or more servers for distribution with said one or more verification codes to said one or more customers by accessing their one or more customer devices and said one or more customers may take up said one or more offers by communicating said one or more verification codes to said one or more sellers; and

a client side display module operable for displaying indicia relevant to the or each seller, the or each offer and a code or codes associated therewith for viewing on selected ones of said client devices.

In another aspect, the present invention resides broadly in a method of electronic commerce including:

operating a server side program on one or more servers;

communicating with a plurality of client devices comprising one or more customer devices and one or more seller devices;

receiving and storing customer information relevant to one or more customers associated with said one or more customer devices by execution of a membership module within said server side program;

receiving and storing seller information relevant to one or more sellers associated with said one or more seller devices by execution of a seller module within said server side program;

providing a data module operatively associated with said seller module;

accessing said data module by said one or more sellers and storing information relevant to one or more offers; generating one or more verification codes associated with the or each offer for distribution to said one or more sellers; and

comparing said one or more verification codes associated with the or each offer with said server side communications module and said data module for distributing said one or more offers to said one or more customers;

operating a client side program on each one of said plurality of client devices in order to communicate with said one or more servers, whereby said one or more sellers may upload one or more offers to said one or more servers for distribution with said one or more verification codes to said one or more customers by accessing their one or more customer devices and said one or more customers may take up said one or more offers by communicating said one or more verification codes to said one or more sellers; and

displaying indicia relevant to the or each seller, the or each offer and a code or codes associated therewith for viewing on selected ones of said client devices.

Preferably, the client side program is formed for operation on one or more mobile telephones as the one or more client devices hereinbefore described. More preferably, the mobile telephones are smart mobile telephones having capability to operate computer code in the form of a small application program, commonly referred to as an “app”.

In such form, the app is operable to request input from each customer once downloaded from a source, such as an app store, for registration of the customer as a user. Once the requested information, or at least the minimum required information, has been uploaded to the one or more servers, the user is able to receive an offer or offers from the one or more sellers. The offers are provided in the form of a ticket which includes details of the offer and seller, a seller identification code and a ticket verification code being the verification code generated by the data module of the client side program.

It will be seen that the electronic redeemable ticket system according to the invention has no interaction between the seller and the customer until the customer makes a purchase using the redeemable ticket offered by the seller through the app, thereby providing an improvement in the use of electronic commerce. The seller and the customer deal with the system independently from one another, the interaction being only by way of the making of a purchase and using the verification code provided to them by the system in electronic commerce to redeem the ticket.

In order that the invention may be more readily understood and put into practical effect, an exemplary embodiment of the present invention will now be described with reference to the following drawings, and wherein:

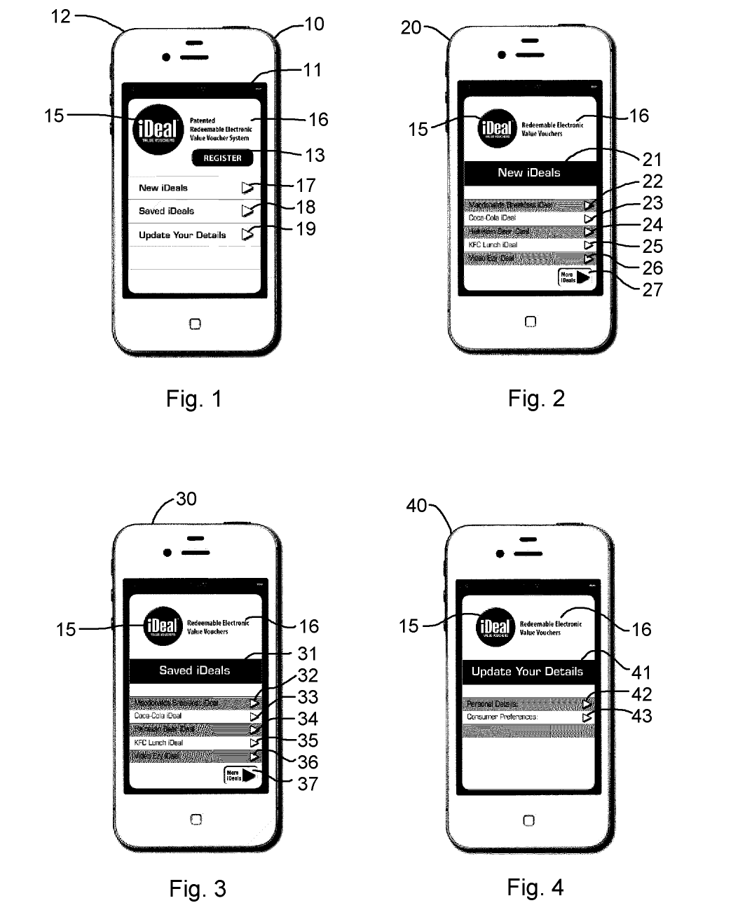

FIGS. 1 to 6 each show a diagrammatic representation of the screen of a smart telephone having installed thereon an app for use with the electronic commerce ticket comprised in a redeemable ticket system according to the invention; and

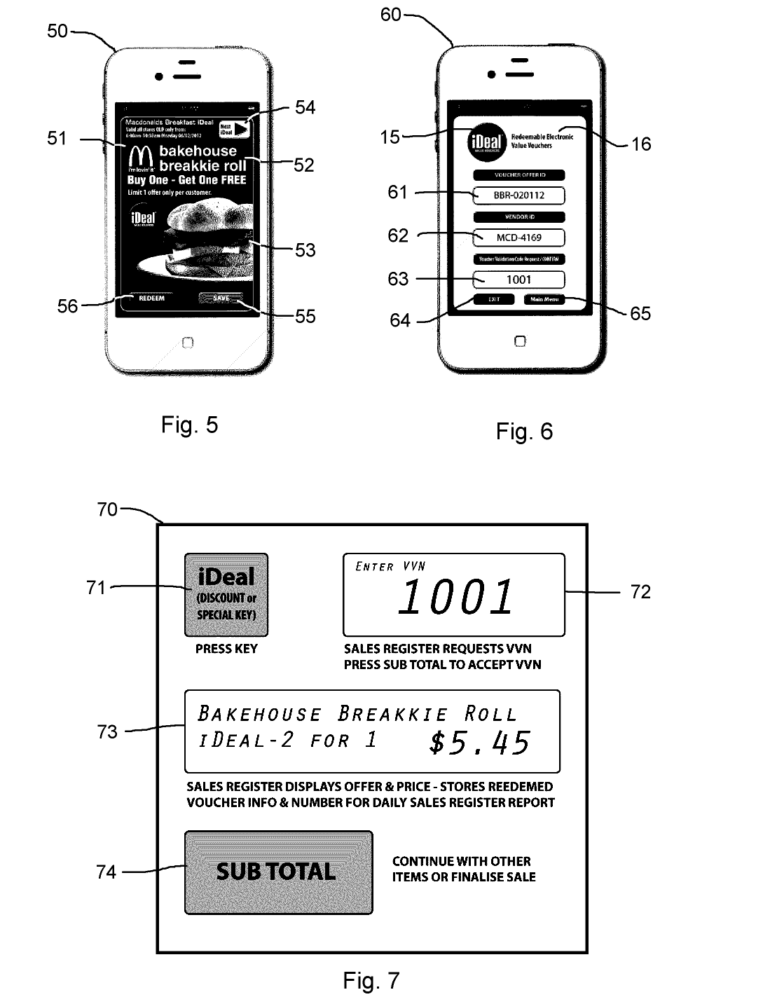

FIG. 7 is a diagrammatic representation of the screen of a retailer's point of sale register and showing the redemption of the redeemable ticket of FIGS. 5 and 6.

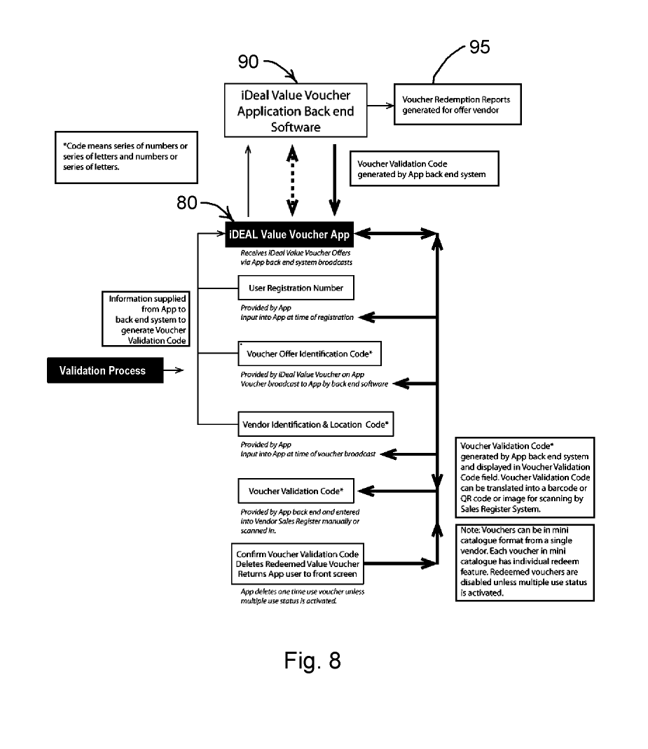

FIG. 8 is a diagrammatic program flow diagram summarising the client side operation of the electronic commerce ticket comprised in a redeemable ticket system according to the invention;

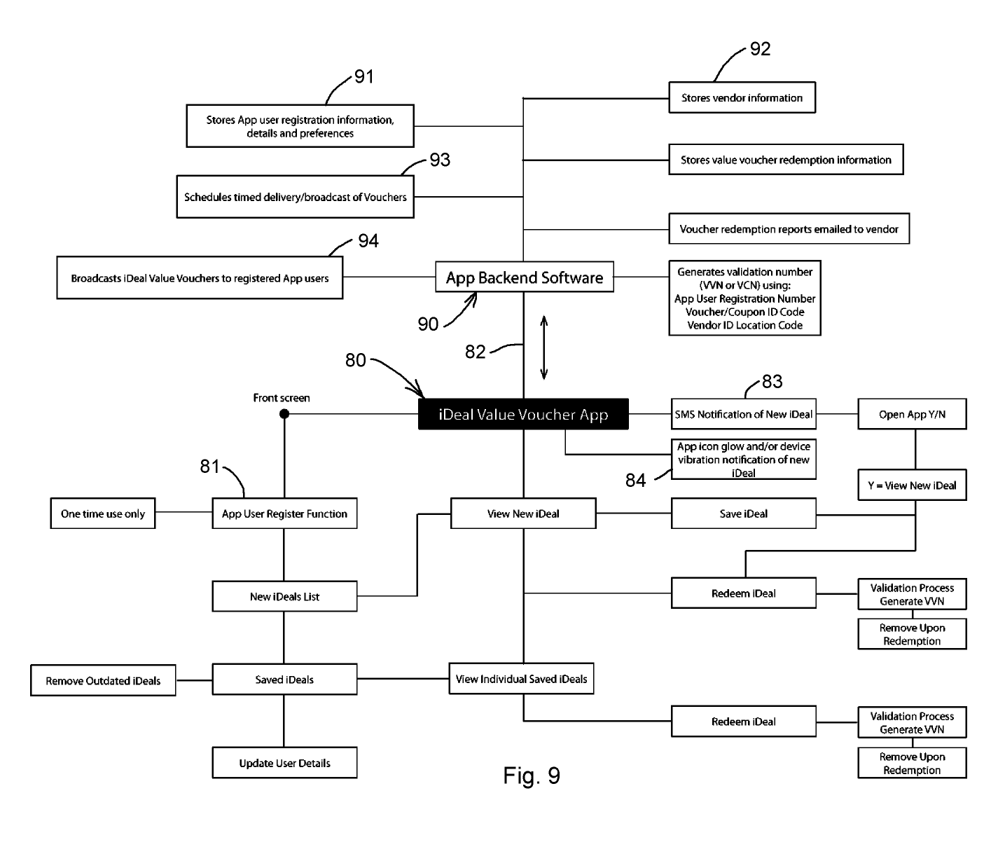

FIG. 9 is a diagrammatic program flow diagram providing more detail of the than that of FIG. 8 and including the server side operation of the electronic commerce ticket comprised in a redeemable ticket system according to the invention.

In the description of the exemplary embodiment, trade marks belonging to respective trade mark owners appear, and it will be appreciated that such trade marks are used as illustrative examples only, and no claim is made thereto by the applicant or inventor.

The electronic redeemable ticket system according to the invention includes an app installed on the smart telephone 10 illustrated in FIGS. 1 to 5. The smart phone includes a touch activated screen 11 which may be tapped or swiped, the swiping being with one, two or three fingers to operate the smart phone in accordance with its normal operating system software. The app installed on the smart phone interfaces with the operating system software in accordance with the application program interface parameters, and in FIG. 1 presents an initial screen 12 to the user having an app icon 15 to the upper left and to the right thereof, a descriptive epithet 16 indicating by the words “redeemable electronic value vouchers” that the app is running for the electronic commerce ticket comprised in a redeemable ticket system according to the invention, being that portion of the system hereinbefore described as part of the client side program and that the user may register by the screen title epithet “REGISTER” at 13.

The initial screen also provides touchable links verbalized as “New iDeals” at 17, “Saved iDeals” at 18 and “Update Your Details” at 19, though which the user may access a new offer screen 20 illustrated in FIG. 2, a saved offer screen 30 illustrated in FIG. 3 and a user details screen 40 illustrated in FIG. 4. Each of the touchable links has a right-hand arrow functioning as the touchable link, but the screen may be programmed for the touchable link to extend across the words if desired.

The new offer screen, saved offer screen and user details screen also include the app icon and descriptive epithet in the upper region of the screen as shown and in the same or similar positions to that illustrated in respect of the initial screen illustrated in FIG. 1. The new offer screen illustrated in FIG. 2 has the title “New iDeals” at 21 and includes a plurality of touchable links verbalized as “MacDonalds Breakfast Deal” at 22, “Coca-Cola deal” at 23, “Heineken Beer Deal” at 24, “KFC Lunch Deal” at 25 and “Video Ezy Deal” at 26 as well as “More iDeals” at 27 which when activated presents another new offer screen similar to that illustrated, but with different offers, those being shown being exemplary only. Of course, there may be as many new offer screens generated as required to accommodate the number of new offers available on the system.

The saved offer screen illustrated in FIG. 3 has its title “Saved iDeals” at 31 and includes the touchable links in a similar fashion to those described with reference to FIGS. 1 and 2, verbalized as “McDonalds Sundaes Deal” at 32, “Coca-Cola Deal” at 33, “Heineken Beer Deal” at 34, “KFC Lunch Deal” at 35 and “Video Ezy Deal” at 36 as well as “More iDeals” at which when activated presents another saved offer screen similar to that illustrated, but with different offers.

The user details screen illustrated in FIG. 4 has its title “Update Your Details” at 41 and includes touchable links in similar fashion to those described with reference to FIGS. 1 to 3, verbalized as “Personal Details” at 42 and “Consumer Preferences” at 43.

When the user activates any one of the touchable links to an offer illustrated in FIG. 2 or 3, an offer screen 50 is revealed which has details of the offer shown at 51, the example shown being for a McDonalds “bakehouse breakkie roll” at 52 having an illustration at 53. Touchable links are also provided for viewing the next offer at 54, to save the offer at 55 or to redeem the offer at 56. When the user activates the touchable link to redeem the offer, a validation screen 60 is revealed which has the voucher code at 61, vendor identification and location code at 62 and voucher validation code at 63. Two navigation buttons are also provided below the voucher verification code, being an exit button at 64 which exits the app and a main menu button which returns the user to the main screen illustrated in FIG. 1.

When validating the voucher, the trader may manually record the particulars of the voucher, but if set up to do so, the trader may access the system of the present invention using the point of sale (POS) register, whereupon screen elements displayed as illustrated in FIG. 7 at 70. The activation icon at 71 instructs the sales person to press the application activation key on the POS register, enter the voucher validation code using the POS register keys or touch screen as the case may be, checking the number is correct in the voucher validation code box at 72, checking that the name of the offer is accurate in the offer display at 73, revealing the special offer price. The sale is continued or completed by the appropriate entries by the keys of the POS register, and the total or subtotal of the sale may be displayed at 74.

The program flow illustrated in FIGS. 8 and 9 commences with the downloading of the app by the user from a source such as an app store or such like. The server of the present system may also provide the app for download by incorporating a suitable software module to do so, but it will be appreciated that this operation is somewhat separate from the operation of the system according to the invention.

The client side of the operation 80 illustrated in FIG. 8 is activated using the normal app activation of the smart phone upon which the app is installed. The client side operation is also indicated by the same reference numeral 80 in FIG. 9, and upon an initial activation, a user registration module 81 is executed requiring the user to enter their particulars. The user particulars may be uploaded via the upload and download link 82 whereupon the server side or “back end” software on the server at 90 executes the user registration server module 91. The information so saved may then be used to issue offers to the user according to their settings and/or preferences.

Vendors may interact with the server side or have their information entered into a vendor information module 92 by a third party. The vendor information includes details of offers to be made, such as prices, discounts, multiple offers, discounts and such like, as well as frequency for regularly timed offers and/or timetabling for accommodating anticipated periods of high or low demand. Relevant portions of this information are accessed by the offer scheduling module 93 for the scheduling of timed delivery and/or broadcast of offers. The server side software control module interacts with the offer scheduling module and the user registration module to broadcast one or more relevant offers to one or more selected users through an offer broadcast module 94.

The user can receive one or more offers when broadcast from the server by activating the app. Alternatively or in addition thereto, a client side SMS module 83 is activated whereby the user may receive an SMS or a client side notification module 84 which would normally remain active in background on the smart phone is executed to activate a vibration, sound or indicium on the screen of the phone to let the user know an offer has been made available for receipt by the user. The client side SMS module includes a routine or link to enable the user to open the app and then view, save or redeem the offer as hereinbefore described. The vendor may receive reports generated by a vendor reporting module 95 directly or indirectly.

It will be seen that the system of the present invention provides a method of delivering a specific targeted marketing message or offer directly to the consumer in real time, no matter where that consumer is located and is independent of the need to have any equipment other than a smart device. Upon receipt of the offer or voucher the consumer would then present to the relevant vendor and redeem the offer or voucher.

Redemption will occur once the system has validated the offer by collecting the offer code, vendor code and a validation code that is then created. All redemptions are recorded and able to be accessed at the completion of the campaign. To receive these offers the consumer must sign up and become a member of the group. Membership can be free or paid. Membership entitles the consumer to redeem offers made from time to time from a variety of businesses or groups.

The electronic commerce ticket comprised in a redeemable ticket system of the present invention provides a marketing voucher, coupon or offer that is delivered in real time to a smart device via either the Internet or the mobile networks and is redeemable by the consumer when presented at the vendor store front or web front and upon receipt of a unique validation code. This voucher, coupon or offer is able to be saved to the device for access over a specified timeframe. The ticket is delivered via the Internet or the mobile system to a consumer's smart device advising them of a product or service or discount. The system also allows for the ticket to be saved to the device for use within a predefined timeline or until used. The ticket is redeemed by the consumer attending a vendor store front, web front or facility and enters into their device or the device automatically recognises the vendor identification and on commitment to complete the transaction the device does query the main database for a validation code that is then provided to the vendor. The saved offer may be removed from the consumers device once the offer has been redeemed or if the offer has not been redeemed before the date and time of expiry. The system may also issue a reminder that there are saved offers nearing expiry on predetermined time points. The system provides a membership database that contains relevant personal details as determined by the operator from time to time.

The app according to the invention is downloadable from a predetermined website. Users must complete a registration process in order to use the app and thereby take advantage of its electronic commerce application. This process involves providing information regarding smart device platform; name, age, gender, occupation, suburb where they live, suburb where they work, mobile phone number and email address, as well as a section on consumer preferences. Ticket delivery can be targeted by assessing consumer preferences, country, state, zip or post code, age range, and gender at predetermined times. Vendor/s notified via email twenty-four hours prior to offer being broadcast to App users.

Offers are broadcast to targeted smart device app users via a timed delivery portal. There are two price categories for advertisers: Firstly, a standard delivery is provided wherein the user is alerted to new offers via smart device vibration and flashing App icon. Secondly, a premium delivery is provided which includes the features of the standard delivery, but also provides a text alert. In such form, a text message is generated by the app and sent to the smart phone on which the app resides, alerting the app user to the brand and details of the offer. Offers are redeemed via a one-time only validation process which enables tracking of voucher redemptions. Once an offer is redeemed or goes out of date, it is automatically deleted from the smart device app. Ticket redemption reports are returned to the offer vendor at end of redemption period.

As most smart phone devices use a touch screen interface, a typical application provides an icon on the screen which can be made to flash or such like when an offer is available. When the user touches flashing app icon, the latest offer is displayed. The user can save offer for later use or return, (e.g. “swish back”) to main phone interface. The offer automatically resides in a new menu. The saved offer menu is automatically displayed after the offer menu.

In a preferred form, each user must provide personal registration information and complete a consumer preferences questionnaire to enable distribution of relevant discount tickets to the appropriate target audience. The register function is automatically deleted from the app after the user registration process is completed. Only one registration per smart phone number is allowed.

Tapping on the “New iDeals” icon or link displays that day's new tickets. Saved iDeals automatically follow on from the “New iDeals” screen. Tapping an “iDeal Value Voucher” icon or link displays the Value Voucher and allows for redemption.

Tapping on the “Saved iDeals” icon displays saved iDeals and allows recall of saved iDeals. Tapping on the “Update Your details” icon or link allows the user to update personal information and consumer preferences on the iDeal Value Vouchers database.

The server side program includes software modules for ticket number generation, redemption and reporting system, and management of data relating to the user registration number recorded from smart device app, discount ticket offer identification codes recorded from the displayed discount ticket offer. The vendor identification location code is validated by a location system, such as GPS or using zip or postal code based software, whereby the app automatically selects the vendor location.

The discount ticket validation code is generated by the app back end system and displayed in the validation code field, recorded as an app request and broadcast back to smart phone, entered into the vendor register as validation for redemption of the active discount ticket. The validation code can optionally be translated by the smart device app and presented as a barcode or QR code in the validation field for scanning by the vendor sales register system. There is also provided an option to delete the ticket, the user being required to confirm to exit this screen. The “confirm” icon, button or link automatically deletes the redeemed ticket from smart device unless multiple use status is activated. All out of date/time value range vouchers are automatically deleted from App. Reporting each discount ticket redemption is recorded via the back end system and reports issued for participating locations at end of promotion.

In operation of the exemplified embodiment of the system, the following may be noted: Offer is validated at vendor front end by meeting set criteria, including firstly:

Condition of sale—Sales register operator requests to view offer at beginning of purchase cycle.

Sales register operator verifies Vendor ID code and subsequent value voucher number (VVN) that is generated.

Vendor sales register operator presses programmed iDeal Offer Key—sales register requests VVN.

Sales register operator enters 4 digit VVN validated by SmartPhone App into sales register.

Sales register records VVN and completes transaction. Sales register programmed to accept an individual VVN one time only per promotion and will display “invalid number entered” if the voucher having that VVN has already been redeemed. Daily sales register report details redeemed.

Value Voucher numbers to be cross checked against emailed iDeal VVN report for location promotion.

Secondly: Offer is validated at back end by meeting set criteria:

Smart phone date and time=Offer date and time value range.

GPS location=Set GPS coordinates for Vendor ID.
Once above criteria are met a VVN is issued.
Number is only issued once.
Value Voucher is automatically deleted from App after redemption.

Secure Sales Register Interface and

Reporting Software System

Redemption Process

Vendor programmes iDeal Value Voucher info & validity into sales register, Sales register operator views vendor location and validated validation code and follows the following procedure:

1. Presses iDeal key on sales register;

2. Enters requested VVN—presses sub-total to accept VVN;

3. Sales register displays iDeal and price;

4. Presses sub-total to continue with additional items or Total to finalise transaction.

Notes:

The validation code is generated by iDeal back end software one time only for each individual voucher. Sales register will only accept one individual validation code per offer. If a duplicate validation code is entered the sales register will display a message: “invalid number entered —transaction cancelled”.

Reporting System

1 Sales register tallies redeemed VVNs attached to individual offer.

2. iDeal Value Voucher back end software emails redeemed VVN report to vendor at end of sales period.

3. Vendor cross checks sales register tally report against iDeal sales report to allow detection of incorrect or fraudulent use of this system.

Although the invention has been described with reference to a specific example, it will be appreciated by persons skilled in the art that the invention may be embodied in other forms within the broad scope and ambit of the invention as herein set forth and defined by the following claim.

1. An electronic commerce ticket comprised in a redeemable ticket system including:
a server side program operable on one or more servers and having:
a server side communications module operable for communication with a plurality of client devices comprising one or more customer devices and one or more seller devices;
a membership module associated with said server side communications, module and operable to receive and store information relevant to one or more customers associated with said one or more customer devices;
a seller module associated with said server side communications module and operable to receive and store information relevant to one or more sellers associated with said one or more seller devices;
a data module operatively associated with said seller module and accessible by said one or more sellers for storing information relevant to one or more offers and generating one or more verification codes associated with the or each offer for distribution to said one or more sellers; and
a control module associated with said server side communications module and said data module for distributing said one or more offers to said one or more customers, and comparing said one or more verification codes associated with the or each offer;
a client side program operable on each one of said plurality of client devices and having:
a client side communications module operable for communication with said one or more servers, whereby said one or more sellers, may upload one or more offers to said one or more servers for distribution with said one or more verification codes to said one or more customers by accessing their one or more customer devices and said one or more customers may take up said one or more offers by communicating said one or more verification codes to said one or more sellers,
the client side communications module also being operable to request input from each customer once downloaded from a source for registration of the customer as a user where, upon at least a minimum required information being uploaded to the one or more servers, the user is able to receive an offer or offers from the one or more sellers
and wherein the offers are provided in the form of a ticket which includes details of the offer and seller, a seller identification code and a ticket verification code being the verification code generated by the data module of the client side program, there being no interaction between the seller and the customer until the customer makes a purchase using the redeemable ticket offered by the seller.

2. The electronic commerce ticket according to claim 1, wherein the client side program is formed for operation on one or more mobile telephones as the one or more client devices.

3. The electronic commerce ticket according to claim 2, wherein the mobile telephones have capability to operate computer code in the form of an app.

4. A method of electronic commerce including:
operating a server side program on one or more servers;
to communicate with a plurality of client devices comprising one or more customer devices and one or more seller devices;
to receive and store customer information relevant to one or more customers associated with said one or more customer devices by execution of a membership module within said server side program;
to receive and store seller information relevant to one or more sellers associated with said one or more seller devices by execution of a seller module within said server side program;
providing a data module operatively associated with said seller module;
accessing said data module by said one or more sellers and storing information relevant to one or more offers,
generating one or more verification codes associated with the or each offer for distribution to said one or more sellers; and
comparing said one or more verification codes associated with the or each offer with said server side communications module and said data module for distributing said one or more offers to said one or more customers;
downloading a client side program from a source for registration of the or each customer as a user,
running the client side program
to request input from each customer once, upon at least a minimum required information being uploaded to the one or more servers, whereupon the customer receives an offer or offers from the one or more sellers;
to communicate with said one or more servers, whereby said one or more sellers may upload one or more offers to said one or more servers for distribution with said one or more verification codes to said one or more customers by accessing their one or more customer devices whereupon said one or more customers may take up said one or more offers by communicating said one or more verification codes to said one or more sellers and
displaying indicia relevant to the or each seller, the or each offer and a code or codes associated therewith for viewing on selected ones of said client devices, there being no interaction between the seller and the customer until the customer makes a purchase using the redeemable ticket offered by the seller.

5. The method according to claim 4, and including a register function wherein each user must provide personal registration information and complete a consumer preferences questionnaire to enable distribution of relevant discount tickets to target audience.

6. The method according to claim 5, wherein the register function is automatically deleted after the user registration process is completed.
